(19) United States
(12) Patent Application Publication
(10) Pub. No.: US 2005/0021596 A1
(43) Pub. Date: Jan. 27, 2005

(54) Internet business directories, and promotion of the same

(76) Inventor: Dung A. Do, Potomoc, MD (US)

Correspondence Address: Whitham, Curtis & Christofferson, PC;Suite 340, 11491 Sunset Hills Road, Reston, VA, 20190, US

(21) Appl. No.: 10/896,920

(22) Filed: Jul. 23, 2004

Related U.S. Application Data
(60) Provisional application No. 60/489,105, filed on Jul. 23, 2003.

(51) Int. Cl. G06F 7/00

(52) U.S. Cl. 709/200

(57) ABSTRACT

An Internet business directory for a geographical place (such as a country, city, town or county), wherein the Internet address for the business directory includes the name of the geographical place, and wherein at least one drop-down menu is used, is easy to use and benefits consumers and advertisers alike. Further advantages may be realized by also using a vehicle with an at least one exterior marking stating the. Internet address which corresponds to the Internet business directory, with a facility inside the vehicle for signing-up advertisers to advertise on the Internet business directory.

### RELATED APPLICATION

This application claims priority from U.S. provisional pat. application No. 60/489,105 filed Jul. 23, 2003.

### BACKGROUND OF THE INVENTION

Although the Internet presents exciting opportunities for businesses (such as restaurants, florists, pet services, cleaning services, sporting facilities, car dealerships, etc.) to advertise to a huge (and growing) pool of potential customers, there remains the problem of how to cause a potential customer to reach posted content (such as an Internet website) that the business may want the customer to view. For example, the business may have a website, but the potential customer may have never heard of the business (or may have forgotten the name of the business). Or, the potential customer may know of the business (such as, for example, from being told about it by friends) but not know the web address. Thus, the conventional Internet directories are not entirely satisfactory from the perspective of advertising businesses.

From another perspective, that of a consumer, conventional Internet directories have suffered from drawbacks. Before the present invention, it has been difficult and time-consuming and in many cases completely impossible to use the Internet as a computerized “Yellow Pages.”

For example, before the days of the Internet, an individual moving to a new town or city might typically have looked in a hard-copy “Yellow Pages” for a wide variety of needs. Today, with increasing numbers of Internet users, many people perform research, or want to perform research, on the Internet. A common conventional Internet Yellow Pages or business directory is that of Yahoo, used by many because of familiarity through the free email accounts that Yahoo offers. A user goes to the yahoo.com webpage, and can find on the home page the “Yellow Pages” button on which to click, taking you to a screen where you can search by name (typing your word of interest) in a search box or by clicking on a subject-matter category (e.g., Automotive), or by clicking on the “Change Location” button. If you click on “Change Location”, you have to decide what to type into the “City, state or zip” box. For example, if you typed “mclean”, you are prompted to choose Mclean Tex., Mclean Ohio or Mclean Nebr. However, the town of McLean, Va. is not represented. If you tried typing “McLean”, you still would not get a choice in Virginia. Then, if you go back a screen, locate the “City Guides” button, and click, you would be advanced to another screen permitting you to pick a major city or to browse by state. If you clicked on “Virginia”, you then have to choose again, such as between “Cities”, “Metropolitan Areas”, “Counties and Regions”. Clicking on “Cities” takes you to a page of cites starting with “A” and alphabet buttons. From that alphabet-button screen, clicking on “M” takes you to the page with Virginia cities starting with “M”, where you will find a button for “McLean”. Clicking on the “McLean” button takes you to a screen having buttons for “Business and Shopping”, “Community”, “Education”, “Employment”, “Entertainment and Arts”, “Health”, “Real Estate”, “Recreation and Sports”, and “Travel and Transportation.” That is a relatively large amount of clicking and decision-making to get to a screen potentially of interest. Such a time-consuming process is likely to deter potential customers from proceeding all the way to whatever content may be “buried” at the end of all the clicking.

Another possible approach that an individual new to McLean might try is to go to google.com or yahoo.com and type “McLean Yellow Pages”. Doing so brings up as a first option, “McLean Yellow Pages and McLean VA Guide”, a site for mclean.areaconnect.com. The mclean.areaconnect.com appears to be connected to a family of websites, including, e.g., richmondva.areaconnect.com, etc.

On the home page of mclean.areaconnect.com, there are are buttons for “McLean Websites”, “McLean Zip Codes”, “McLean Colleges and Universities”, “Driving Directions”, “McLean Hotels” and “McLean Movies”, with another set of “Yellow Page” buttons for “McLean Flowers”, “McLean Restaurants” and “McLean Attorneys.” Clicking on “McLean Restaurants” brings up a screen where you can search further, but you have to figure out whether to search over “SmartPages”, “QwestDex”, “RealPages”, “YP @ WhitePages”, “SuperPages”, “RealPages” or to push the grey button “Search Yellow Pages”. So there is more clicking and attempting involved. Clicking on the grey “Search Yellow Pages” button brings you to a screen with a list of categories, “Barbecue (1)”, “Cafes (4)”, Cafeterias (2), Caterers (79), Delicatessens (111), Dieticians (3), Foods-Carry Out (53), Hot Dog Stands (1), Pizza (113), Restaurant Equip-Repair & Serv (7), Restaurant Management (5), Restaurants (1207), Restaurants & Pizza (2) . . . etc. If you click on “Restaurants (1207)”, you get a screen on which, scrolling down, first you encounter Papa Johns and Carlos O'Kelly's followed by restaurants with names starting with “A”. To get to any restaurant starting with a different letter, you would have to click on another letter and go to that page, which is a highly undesirable feature from the viewpoint of business advertisers beginning with letters other than “A”.

Thus, while Internet business directories have been attempted before the present invention, those Internet business directories are far from ideal. Existing Internet business directories fall short of users' needs, such as user-friendliness, simplicity, and actually providing useful information that the user is seeking.

Challenges are presented for someone who may want to provide a more user-friendly Internet business directory than conventionally-available Internet business directories. For example, for someone who may know how to create a more user-friendly Internet business directory, there still is the non-trivial question of how to reach business advertisers and interest them in being included in the new Internet business directory.

### SUMMARY OF THE DRAWINGS

FIG. 1 is a printout from an Internet webpage according to the invention.

FIG. 2 is a printout from an Internet webpage according to the invention, with a drop-down menu shown.

FIG. 3 is a representational drawing of an Internet webpage according to the invention.

FIG. 4 is a three-dimensional view of a vehicle according to the invention.

### SUMMARY OF THE INVENTION

The present invention innovatively addresses and maximizes the benefits to both Internet-user and advertising business. By using the inventive methods, systems, and products, a highly user-friendly Internet business directory can be provided.

In a first preferred embodiment, the invention provides an Internet business directory for a geographical place (such as a country, city, town, county, etc.) wherein the Internet address for the business directory includes the name of the geographical place, and wherein at least one drop-down menu is used on at least one web page of the Internet business directory.

Optional preferred details for inventive Internet business directories are as follows. The, Internet address preferably includes an eyecatching prefix and/or suffix; such as, e.g., an Internet of the form of a geographical title followed by “411.com”, etc. The Internet address preferably is being displayed on an exterior of a van being driven and/or parked in the geographical place, wherein the van contains a facility for signing-up advertisers to advertise on the Internet business directory. A preferred example of an inventive Internet business directory is a truly-geographical Internet index website, in which search results do not include restaurants, businesses or other items that are out of the geographical area.

In another preferred embodiment, the invention provides an advertising system, comprising: a vehicle (such as, e.g., a van, etc.) with an at least one exterior marking stating an Internet address which corresponds to an Internet business directory, with a facility inside the vehicle for signing-up advertisers to advertise on the Internet business directory (such as, e.g., a computer facility with an ability to display, live, the website of the Internet business directory corresponding to the Internet address marked on the exterior of the vehicle, etc.), such as, e.g., an advertising system including a van in which is housed a computer facility wherein information from an advertiser or prospective advertiser may be taken for setting up, within the hour, a new advertiser, for advertising on the Internet business directory. Inventive advertising systems may include print material that is an invitation or admission card for a business to visit the vehicle.

### DETAILED DESCRIPTION OF A PREFERRED EMBODIMENTS OF THE INVENTION

For accomplishing the present invention, a domain name is purchased, preferably, an easy-to-remember and easy-to-type domain name. An example of an easy-to-remember domain name is one ending in a catchy suffix (such as 411.com, etc.) or beginning with a catchy prefix. Most preferably, the domain name to be used in practicing the invention begins with a geographical place name (such as a town or city name, etc.) and ends in a catchy suffix, such as, e.g., the domain name McLean411.com.

For the domain name, a framework of home page and underlying pages must be designed. Most preferably, principles of click-minimization and/or minimization of page-accessing are used, minimizing how much clicking a user must do before arriving at his target information (such as restaurant information, taxi information, etc.) For example, drop-down bars may be used for displaying accessible information without requiring the user to actually go to the next page to find out that information.

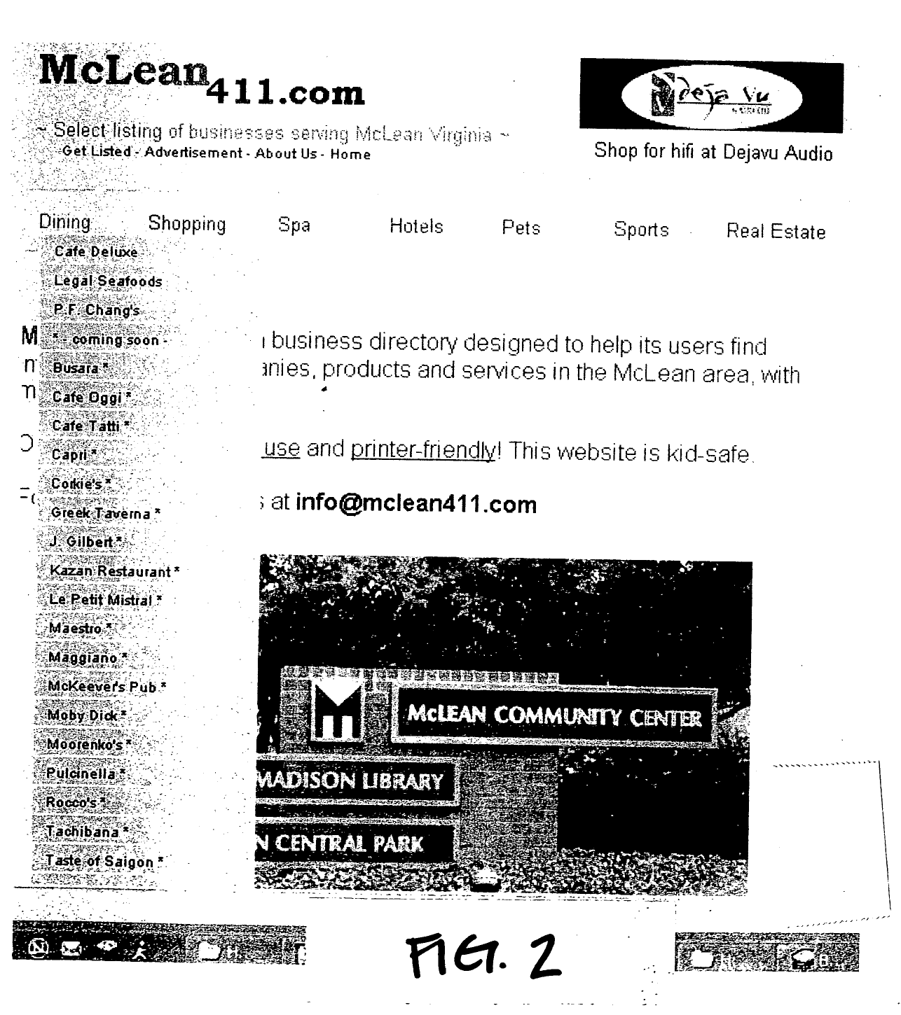

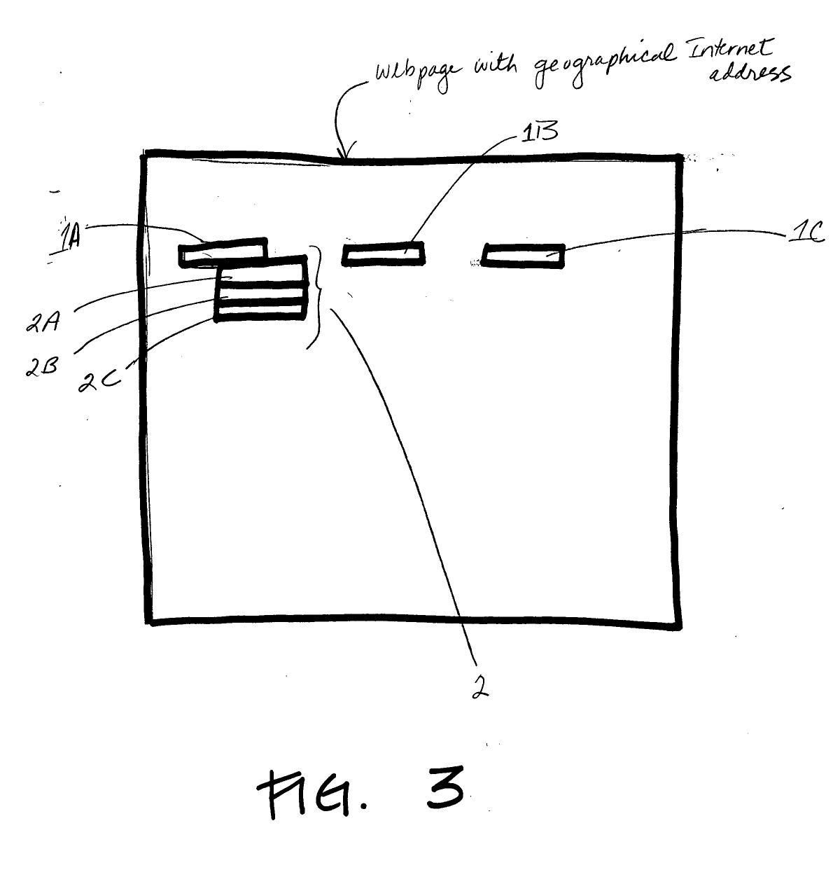

With reference to FIG. 3, a webpage according to th invention with a geographical Internet address is shown. The webpage of FIG. 3 is a 411-style webpage and includes at least one category button 1A. Preferably a plurality of category buttons 1A, 1B, 1C etc. are included. Non-limiting examples of categories are Dining, Shopping, Spa, Hotels, Pets, Sports, Real Estates, etc. From at least one of the category buttons, is provided a drop-down menu 2. A drop-down menu 2 includes at least one drop-down item, preferably a plurality of drop-down items such as drop-down items 2A, 2B, 2C shown on FIG. 3. An example of a drop-down menu is shown on FIG. 2 (the Dining drop-down menu). Preferably, upon clicking on a drop-down item, access to information about the drop-down item is provided (such as another page about the particular drop-down item). The drop-down approach is highly advantageous and consumer-friendly, by permitting display of a plurality of selections within a category, such as a plurality of different restaurants within a Dining category, without the consumer needing to click back and forth between a Dining screen and individual screens for restaurants. The consumer can visually survey a plurality of selections within a category without needing to leave the screen on which the category itself first appears.

The invention in a first preferred embodiment provides for a user-friendly Internet business directory that is geographically localized (e.g., McLean411.com for McLean, Va).

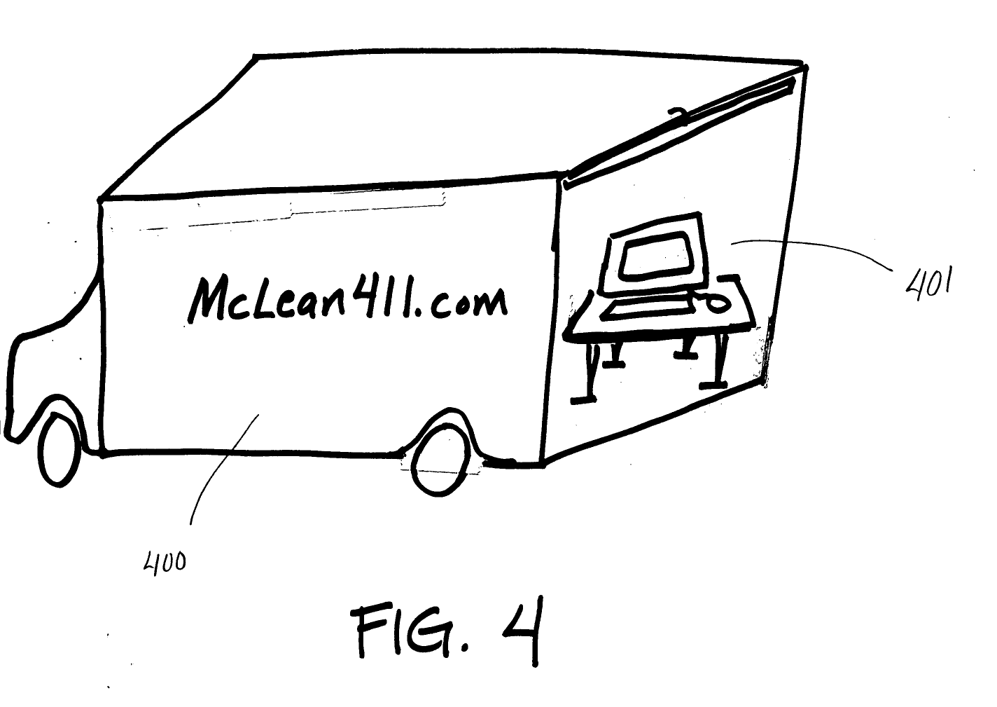

In a highly preferred embodiment, the invention optionally provides for using a mobile vehicle (such as a van or recreational vehicle (RV)) to develop the website content, wherein the website domain name is prominently featured on the vehicle exterior (such as, for example, a van bearing on its exterior, prominently, “the McLean411.com van”) and wherein inside the vehicle is a website development center. For example, see FIG. 4, showing a McLean 411.com van 400 inside which is a website development center 401.

Such an exterior-marked vehicle according to the present invention may be used in at least one or more of the following ways: driving the exterior-marked vehicle in the geography corresponding to the Internet business directory for which the vehicle is marked; driving and/or parking the exterior-marked vehicle in proximity to at least one business which is targeted as a possible advertiser; distributing (by mail, hand-delivery, etc.) print material inviting a possible business advertiser to the exterior-marked van; setting up a computer facility in the vehicle, wherein a business advertiser prospect can view, live, the Internet business directory for which his advertising is sought and/or can purchase advertising (including, most preferably, his providing sufficient information for his advertising on the Internet business directory to go live on-site in the vehicle, or soon after, such as within one day). Most preferably, the inventive vehicle has inside it a one-hour set-up, for setting up a new advertiser within an hour.

Advantageously, first exterior markings on the vehicle relating to an Internet business directory for a first geography may be removed or covered so as to remark the vehicle with second exterior markings relating to an Internet business directory for a second geography. That is, for example, the McLean411.com van's exterior markings easily could be changed to instead make it the Reston411.com van.

In another preferred embodiment, the invention provides for a series of geographically-based Internet business directories that are related by sharing a common suffix and/or prefix, e.g., a series ending in suffix “411.com”.

### INVENTIVE EXAMPLE 1

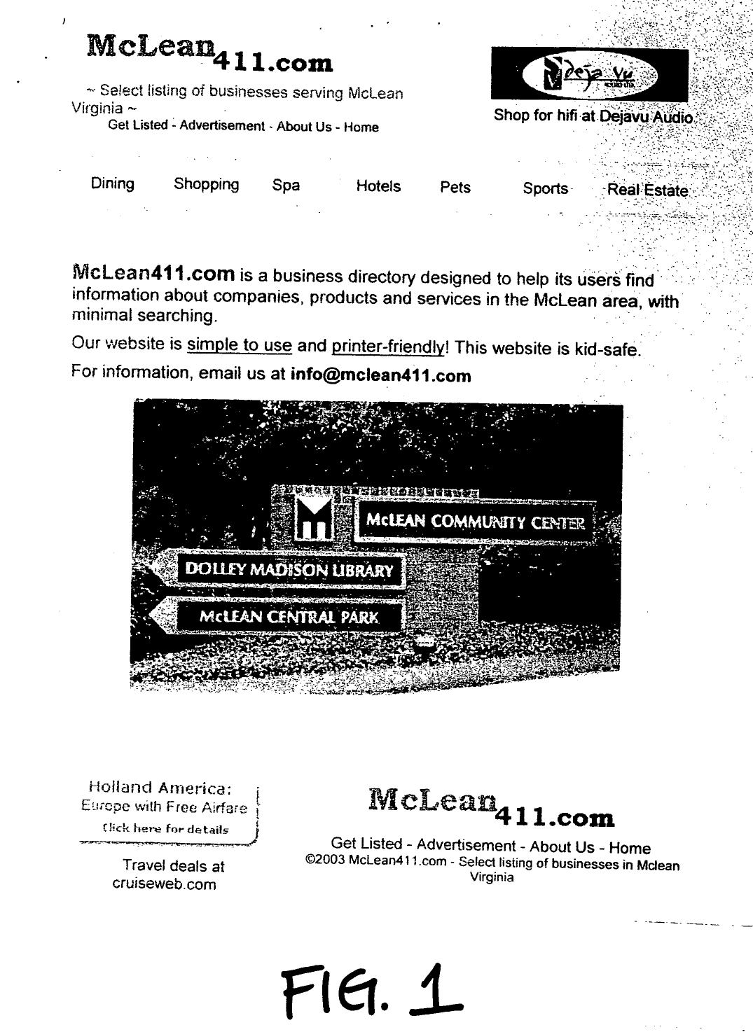

Screen(s) for McLean411.com, for an Internet business directory for McLean, Va., were live and available to the public at www.McLean411.com. FIG. 1 was printed from a live screen, http://www.mclean411.com/index.html. FIG. 2 was printed from a live screen and shows the drop-down screen that appeared when the mouse was poised at “Dining” (which was in red on the live screen).

### INVENTIVE EXAMPLE 2

A van with its exterior marking “McLean411.com”, inside which van is contained a computer facility.

### INVENTIVE EXAMPLE 3

The van of Inventive Example 2, in which the computer facility includes the ability to display, live, the website McLean411.com.

### INVENTIVE EXAMPLE 3

The van of Inventive Example 2, in which the computer facility includes the ability to take information for setting up, within the hour, a new paying advertiser that is a McLean business, for McLean411.com.

### INVENTIVE EXAMPLE 4

Print material that is an invitation or admission card for a McLean business to visit the McLean411.com van.

INVENTIVE EXAMPLE 5

A truly-geographical Internet index website is established, in which search results do not include items (e.g., restaurants or other businesses) that are out of the geographical area. In the case of McLean411.com, only McLean, Virginia items are included as accessible search results in this Example 5.

### INVENTIVE EXAMPLE 6

The geographical place may be a country, such as, e.g., Malaysia with an example of an Internet address of, e.g., Malaysia411.com.

### INVENTIVE EXAMPLE 7

The geographical place may be a city, such as, e.g., Paris, with an example of an Internet address of, e.g., Paris411.com.

It will be appreciated that variations and modifications from the embodiments set forth above may be made without departing from the spirit of the invention, and that such modifications are within the present invention.

1. An Internet business directory for a geographical place, wherein the Internet address for the business directory includes the name of the geographical place, and wherein at least one drop-down menu is used on at least one web page of the Internet business directory.

2. The Internet business directory of claim 1, wherein the geographical place is selected from the group consisting of a country, a city, a town and a county.

3. The Internet business directory of claim 1, wherein the Internet address includes an eyecatching prefix and/or suffix.

4. The Internet business directory of claim 3, wherein the Internet address is of the form of a geographical title followed by “411.com”.

5. The Internet business directory of claim 1, wherein the Internet address is being displayed on an exterior of a van being driven and/or parked in the geographical place, and wherein the van contains a facility for signing-up advertisers to advertise on the Internet business directory.

6. The Internet business directory of claim 1, including a truly-geographical Internet index website, in which search results do not include restaurants, businesses or other items that are out of the geographical area.

7. An advertising system, comprising:
a vehicle with an at least one exterior marking stating an Internet address which corresponds to an Internet business directory, with a facility inside the vehicle for signing-up advertisers to advertise on the Internet business directory.

8. The advertising system of claim 7, wherein the facility is a computer facility with an ability to display, live, the website of the Internet business directory corresponding to the Internet address marked on the exterior of the vehicle.

9. The advertising system of claim 7, wherein the vehicle is a van.

10. The advertising system of claim 7, including a van in which is housed a computer facility wherein information from an advertiser or prospective advertiser may be taken for setting up, within the hour, a new advertiser, for advertising on the Internet business directory.

11. The advertising system of claim 10, wherein the new advertiser is a paying customer of the Internet business directory.

12. The advertising system of claim 6, including print material that is an invitation or admission card for a business to visit the vehicle.
